(19) United States
(12) Patent Application Publication
(10) Pub. No.: US 2005/0005864 A1
(43) Pub. Date: Jan. 13, 2005

(54) Support for a salt lick block

(76) Inventor: Rheal R. Lesage, Notre Dame de Lourdes (CA)

Correspondence Address: ADE & COMPANY, 1700-360 MAIN STREET, WINNIPEG, MB, R3C3Z3, CA

(21) Appl. No.: 10/866,637

(22) Filed: Jun. 14, 2004

(30) Foreign Application Priority Data
Jun. 20, 2003 (CA) 2,432,963

(51) Int. Cl. A01K 1/10

(52) U.S. Cl. 119/51.03

(57) ABSTRACT

A support for a rectangular salt lick block has a mounting frame defined by two arch shaped ends with a pair of parallel rails arranged at spaced parallel horizontal positions such that the block is supported on the rails with one apex of the block between the rails and facing downwardly to define two sides of the block at right angles each of which engages a respective one of the rails. The ends engage ends of the block to prevent longitudinal movement of the block and bars are provided extending from the rails in the plane of the sides of the block.

### BACKGROUND OF THE INVENTION

This invention relates to a support for a salt lick block of the type used by animals to provide additional salt in the feed for nutritional purposes.

It is conventional to supply to animals in pasture or feed on hay a supplemental salt lick in the form of a rectangular block. While blocks are not particularly expensive, it is highly desirable to avoid unnecessary waste of the block and thus it is desirable to support the block in a suitable manner which prevents it being damaged by trampling or dissolved by standing in water.

Supports are available in the form of a post and for this purpose the block has a central opening which can be engaged vertically over the post so that the axis of the block lies along the post and the block surrounds the post. This however is a crude mounting arrangement providing a horizontal top surface of the block and a vertical central opening of the block both of which can receive and accumulate moisture from rain or the like causing premature dissolving of the block.

### SUMMARY OF THE INVENTION

It is one object of the present invention, therefore, to provide a support for a salt lick block which supports the block in a more suitable manner to reduce damage and dissolving of the block.

According to the invention, therefore, there is provided a support for a rectangular salt lick block comprising:
a mounting frame for resting on the ground;
a pair of parallel rails carried on the mounting frame and arranged at spaced parallel horizontal positions, the spacing between the rails being arranged such that the block can be supported on the rails with one apex of the block between the rails and facing downwardly to define two sides of the block at right angles each of which engages a respective one of the rails.

Preferably the support includes end bars at ends of the rails for engaging ends of the block to prevent longitudinal movement of the block along the rails.

Preferably the support includes members engaging the block for preventing rotation of the block about its axis parallel to the rails.

Preferably the members engaging the block comprise bars extending from the rails which engage the sides of the block.

Preferably the bars lie in a common plane with the sides of the block.

Preferably each rail is associated therewith a pair of the bars so that the pair of bars for each rail engage a respective one of the sides of the block.

Preferably the rails are mounted on a pair of side frames with each of the side frames arranged at a respective end of the rails.

Preferably the side frames are arranged to engage the ends of the block to prevent movement of the block longitudinally of the rails.

Preferably each side frame includes a bar extending from the side frame to a respective one of the rails for engaging a respective side of the block.

Preferably each of the side frames is generally A-shaped with an upwardly extending apex above and between the rails with the rails attached at each end to a cross bar of the side frame.

Preferably the side frames have an upper apex which is curved.

### DESCRIPTION OF THE DRAWINGS

One embodiment of the invention will now be described in conjunction with the accompanying drawings in which:

FIG. 1 is a side elevational view of the support with a block mounted thereon.

FIG. 2 is an end elevational view of the support and block of FIG. 1.

FIG. 3 is an isometric view of the support of FIGS. 1 and 2.

In the drawings like characters of reference indicate corresponding parts in the different figures.

### DETAILED DESCRIPTION

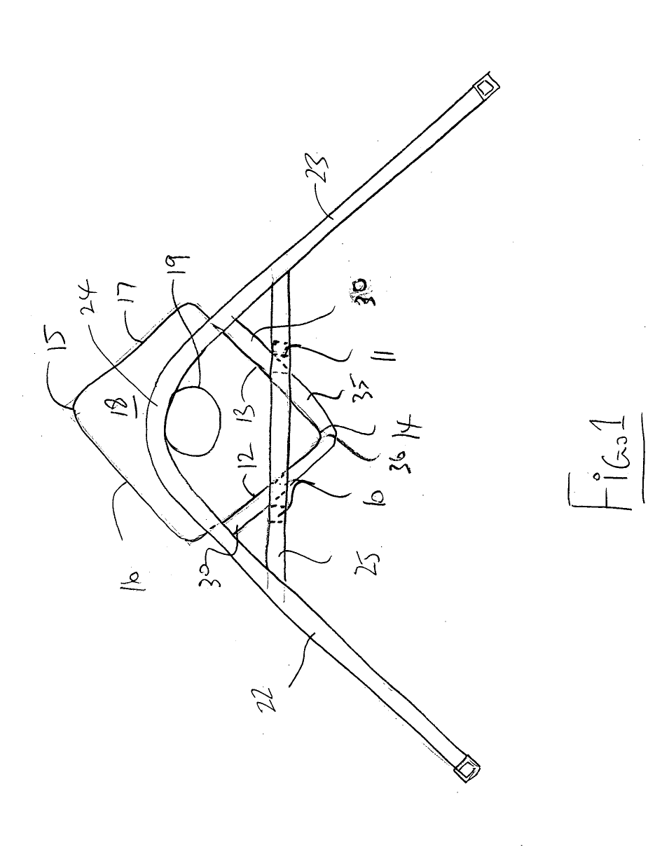

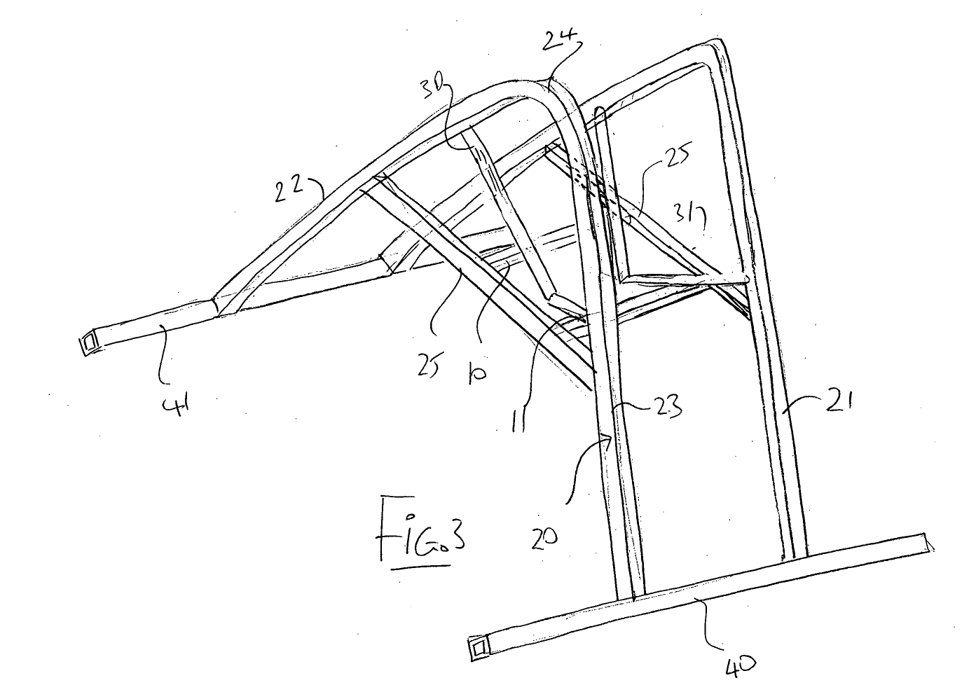

The support as shown in FIG. 3 comprises a rail 10 and a rail 11 which are parallel and horizontal and spaced by a distance as best shown in FIG. 1 so that two sides 12 and 13 of the rectangular block rest against the rails with the apex 14 of the block depending below and between the two rails. In this way the block is supported with a major portion of the block above the rails with an upper apex 15, two upwardly facing surfaces 16 and 17 and two ends 18. A central hole 19 through the block extends from the ends 18 and thus is horizontal in the mounted position shown in FIG. 1. In this arrangement of mounting of the block, the surfaces 16 and 17 which face upwardly are inclined so that any rain or other moisture falling upon the block tends to be shed away from the block rather than remain sitting on the block. The ends 18 are held vertical and the central opening 19 is horizontal so that it does not retain water since it is fully open at both ends for shedding the water.

The two rails 10 and 11 are mounted on side frames 20 and 21. Each side frame 20, 21 is generally A-shaped in side elevation with two outwardly and downwardly inclined legs 22 and 23 at an upwardly facing central curved apex 24. A cross member 25 extends between the two legs of the side frame and provides a support for the ends of the rails 10 and 11. The side frames are spaced by a distance equal to the length of the block between the ends 18 so that the ends 18 lie closely adjacent or abut the side frames at their inside surface. Thus as shown in FIG. 1 the apex 15 is above the apex 24 so that the whole of the curved apex 24 can engage the end face 18 of the block.

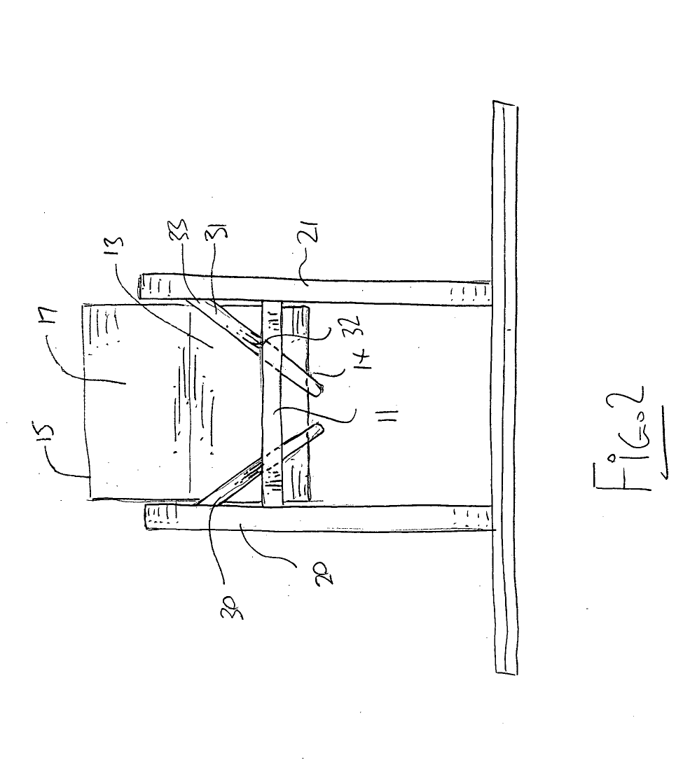

Thus the block is held in position on the rails and is prevent from longitudinal movement between the side frames. The block is also prevented from rotation by four bars arranged in two pairs where the rail 10 has a pair attached thereto and the rail 11 has another pair attached thereto. Thus as shown in FIGS. 1 and 2 the rail 11 has associated with it two bars 30 and 31 forming the pair which lie in the common plane of the surface 13 and each has an upper portion 32 which extends from the top of the rail upwardly and outwardly to the part of the side frame above the cross bar 25. Symmetrically the rail 10 has an identical pair of bars. The bars 30 and 31 of each rail also include lower portions 35 which extend downwardly below the rails 10 and 11 so that the bar 30 of the rail 10 meets the bar 30 of the rail 11 at an apex 36 and symmetrically the bars 31 meet at apex 36A with the apexes spaced apart underneath the corner of the block. The upper end 33 of the bar 31 is connected to the side frame 21 at a position in the plane of the side frame 21 at a height above the rail 11. Thus the surface 13 sits in contact with the bars 31 of the rail 11 and symmetrically the surface 12 sits in contact with the bars 30 of the rail 10. Thus the block sits in position primarily on the rails 10 and 11 but is prevent from rotation about its axis or toppling from the bars by rolling in view of the engagement of the side surfaces with the bars. The block can thus simply sit in place on the support while it is consumed by the animals reducing in dimension until it is sufficiently consumed to fall between the rails. At this time the block can fall to the ground but is sufficiently small that little is wasted, particularly bearing in mind the central hole. The bottom ends of the legs 22 and 23 are mounted on cross bars 40 and 41 which extend parallel to the rails 10 and 11 and provide stability on the ground to prevent the support from toppling in a side to side direction due to pushing by the animals.

The support can be used for different types of animals including sheep, horses, cattle. The support is inexpensive and yet provides a stable and effective support for the block reducing its damage and premature dissolving in rain or standing water.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. A support for a rectangular salt lick block comprising:
a mounting frame for resting on the ground;
a pair of parallel rails carried on the mounting frame and arranged at spaced parallel horizontal positions, the spacing between the rails being arranged such that the block can be supported on the rails with one apex of the block between the rails and facing downwardly to define two sides of the block at right angles each of which engages a respective one of the rails.

2. The support according to claim 1 including end bars at ends of the rails for engaging ends of the block to prevent longitudinal movement of the block along the rails.

3. The support according to claim 1 including members engaging the block for preventing rotation of the block about its axis parallel to the rails.

4. The support according to claim 3 wherein the members engaging the block comprise bars extending from the rails which engage the sides of the block.

5. The support according to claim 4 wherein the bars lie in a common plane with the sides of the block.

6. The support according to claim 5 wherein each rail is associated therewith a pair of the bars so that the pair of bars for each rail engage a respective one of the sides of the block.

7. The support according to claim 4 wherein the bars of each pair converge inwardly and downwardly toward one another.

8. The support according to claim 4 wherein the bars of each pair are arranged such that one bar of each pair meets one bar of the other pair at an apex below the block, with the apexes.

9. The support according to claim 1 wherein the rails are mounted on a pair of side frames with each of the side frames arranged at a respective end of the rails.

10. The support according to claim 9 wherein the side frames are arranged to engage the ends of the block to prevent movement of the block longitudinally of the rails.

11. The support according to claim 10 wherein each side frame includes a bar extending from the side frame to a respective one of the rails for engaging a respective side of the block.

12. The supporting according to claim 7 wherein each of the side frames is generally A-shaped with an upwardly extending apex above and between the rails with the rails attached at each end to a cross bar of the side frame.

13. The support according to claim 12 wherein the side frames have an upper apex which is curved.
